(19) United States
(12) Patent Application Publication
(10) Pub. No.: US 2014/0009510 A1
(43) Pub. Date: Jan. 9, 2014

(54) Display Device with Backlight Dimming Compensation

(71) Applicant: iWatt Inc., Campbell, CA (US)

(72) Inventor: Xuecheng Jin, Palo Alto, CA (US)

(21) Appl. No.: 13/921,180

(22) Filed: Jun. 18, 2013

Related U.S. Application Data
(60) Provisional application No. 61/668,170, filed on Jul. 5, 2012.

(51) Int. Cl. G09G 3/36

(52) U.S. Cl. CPC G09G 3/36
USPC 345/690; 345/102

(57) ABSTRACT

A light emitting display device with backlight dimming compensation. A backlight emits light based on a backlight control signal. A power supply generates a first supply voltage based on a supply control signal. A data driver converts pixel data into analog data voltages. A dynamic voltage range of the analog data voltages is controlled by the first supply voltage. A pixel array includes a plurality of pixels, and transparency of the pixels to the light emitted by the backlight is based on the analog data voltages. A power control module of the display device determines if a power condition is met and, responsive to the power condition being met, adjusts the backlight control signal to reduce a brightness of light emitted by the backlight and adjusts the supply control signal to increase the first supply voltage.

### CROSS-REFERENCE TO RELATED APPLICATION

This application claims priority from U.S. Provisional Patent Application No. 61/668,170, filed on Jul. 5, 2012, the contents of which are incorporated by reference herein in their entirety.

### BACKGROUND

1. Field of the Disclosure

The present disclosure relates to a display device, and more specifically to a display device with backlight dimming compensation.

2. Description of the Related Arts

Liquid crystal displays (LCD) are found in many electronic devices, such as smart phones, monitors, and televisions, to name a few. LCDs typically have a backlight that emits light and a pixel array that controls the amount of light passing through the pixel array. LCDs generally have low power consumption, which allows them to be used in battery powered devices.

With the rise of mobile devices and federal energy efficiency regulations, it has become increasingly important for the LCDs to be even more power efficient. In a LCD, the backlight is responsible for a significant amount of the power consumed by the LCD. Thus, to reduce the power consumed by the LCD, some conventional techniques attempt to dim the backlight. However, dimming the backlight reduces the brightness of the display. This has a detrimental effect on the image quality of the display device that is unacceptable to many users.

### SUMMARY

Embodiments of the present disclosure include a light emitting display device with backlight dimming compensation. In one embodiment, the display device includes a backlight configured to emit light based on a backlight control signal indicative of a backlight brightness setting for the backlight. A power supply is configured to generate a first supply voltage based on a supply control signal indicative of a supply voltage setting for the power supply. A data driver of the display device is configured to convert pixel data into analog data voltages. A dynamic voltage range of the analog data voltages is controlled by the first supply voltage. A pixel array of the display device includes a plurality of pixels, and transparency of the pixels to the light emitted by the backlight is based on the analog data voltages. A power control module of the display device is configured to determine if a power condition is met and, responsive to the power condition being met, to adjust the backlight control signal to reduce a brightness of the light emitted by the backlight and to adjust the supply control signal to increase the first supply voltage.

By reducing a brightness of the backlight, the power consumption of the display device is reduced. At the same time, the brightness of an image displayed at the display device can be preserved by increasing the first supply voltage to the data driver to over-drive the pixel array. The result is a display device that has reduced power consumption without sacrificing image quality.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

The teachings of the embodiments of the present disclosure can be readily understood by considering the following detailed description in conjunction with the accompanying drawings.

FIG. 1 is high level overview of a display device with backlight dimming compensation, according to an embodiment.

FIG. 2 is an LCD pixel and its supporting circuitry, according to an embodiment

FIG. 3 is a detailed view of a data driver, according to an embodiment.

FIG. 4 is a flowchart illustrating a method performed in the display device, according to an embodiment.

### DETAILED DESCRIPTION OF EMBODIMENTS

The figures and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments of the present invention(s), examples of which are illustrated in the accompanying figures. It is noted that wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

In one embodiment, a display device with backlight dimming compensation is disclosed. The brightness of the backlight is reduced in a low power mode, which reduces the power consumption of the display device. At the same time, the brightness of an image displayed at the display device can be preserved by increasing a supply voltage to a data driver to over-drive the pixel array. The result is a display device that has reduced power consumption without sacrificing image quality.

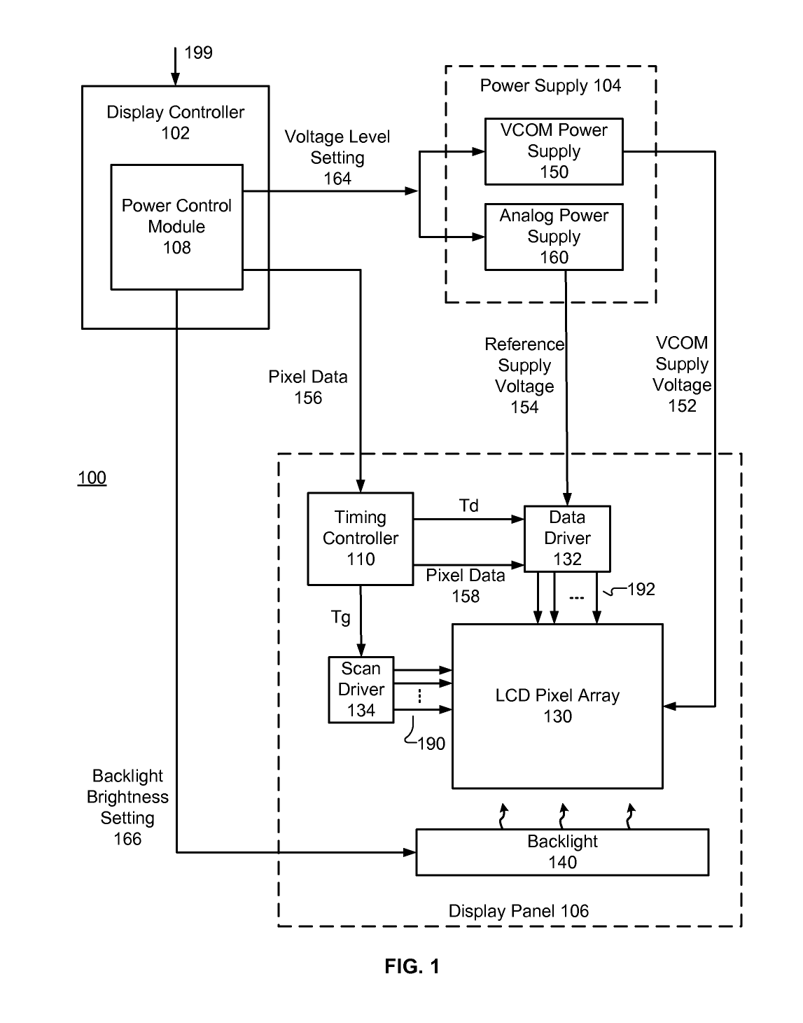

FIG. 1 is high level overview of a display device 100 with dimming compensation, according to an embodiment. The display device 100 includes a display controller 102, a power supply 104 and a display panel 106. In some embodiments, the display device 100 can represent a computer monitor, a television, a laptop computer, a tablet computer, or a smart phone. The display device 100 may also include other components that are not shown in FIG. 1.

The display controller 102 handles the bulk of the image processing in the display device, including dimming of the backlight 140 and adjusting the voltages within the display device 199 to maintain the brightness of the image displayed by the display device 100. In one embodiment, the image processor is a system-on-chip (SoC), an application specific integrated circuit (ASIC), a general purpose processor, or a digital signal processor (DSP).

The display controller 102 receives image frame data via communications link 199. In one embodiment, communications link 199 is a Red-Green-Blue (RGB) video link, YPbPr video link, Color Video Blanking and Synchronization (CVBS) video link, S-Video link, High-Definition Multimedia Interface (HDMI), Digital Video Interface (DVI), Display Port, etc. The display controller 102 may process the image frame data and then output digital pixel data 156 that includes separate intensity levels for the different colors (e.g. Red, Blue and Green) of each pixel in the image frame data. The display controller 102 also outputs a voltage level setting 164 to the power supply 104 and a backlight brightness setting 166 to the backlight 140.

The display controller 102 includes a power control module 108 that controls the amount of power consumed by the display device 100. In one embodiment, the power control module 108 generates a backlight brightness setting 166 for controlling the brightness of the backlight 140. The backlight brightness setting 166 can be communicated to the backlight 140 via one or more backlight control signals. The power control module 108 also generates a voltage level setting 164 for controlling a voltage level of the reference supply voltage 154 and the VCOM supply voltage 152. The voltage level setting 164 can be transmitted to the power supply 104 via one or more power supply control signals.

The power control module 108 can operate in different modes, such as a default power mode and a low power mode. During the default power mode, the control module 108 generates default settings for the backlight brightness setting 166 and voltage setting 164. During a low power mode, the power control module 108 reduces the backlight brightness setting 166 to dim the backlight 140, thereby decreasing the power consumed by the backlight 140. To counteract a decrease in image brightness caused by dimming the backlight 140, the power control module 108 also increases the voltage level setting 164 to increase the reference supply voltage 154 and VCOM supply voltage 152. Increasing the level of the supply voltages 152 and 154 causes the pixel array 130 to be over-driven and counter-acts any decrease in image brightness caused by dimming the backlight 140 without significantly increasing power consumption. Overdriving the pixel array 130 at all times, however, may be detrimental because it reduces the life of the LCD pixel array 130. Having different power modes is thus beneficial because it provides a tradeoff between increased life expectancy in the default power mode and reduced power consumption in the low power mode.

In a further embodiment, the power control module 108 may also adjust the digital values of the pixel data 156 in addition to the voltage level setting 164 during the low power mode in order to counter-act the decrease in the brightness of the backlight 140. The digital values of the pixel data 156 can be increased, for example, by scaling the digital values by a multiplier (e.g. 1.2×). Similar to adjusting the reference supply voltage 154 and VCOM supply voltage 152, increasing the digital values of the pixel data 156 also has the effect of increasing the transparency of the LCD pixel array 30. However, by also adjusting the digital values of the pixel data 156, the increase in the supply voltages 152 and 154 can be reduced to minimize the amount of power consumption attributed to increased supply voltages 152 and 154.

In one embodiment, the backlight brightness settings 166 and voltage level settings 164 can be stored in a look up table that are indexed to the different power modes. Alternatively, the reduction in the backlight brightness setting 166 during the low power mode can be computed as a function of the increase in the voltage level setting 164, or vice versa. For example, the increase in the voltage level setting 165 may be proportional to the decrease in the backlight brightness setting 166. In one embodiment, more than two power modes may be supported by the power control module 108. In one embodiment, the power control module 108 may be implemented with circuitry only or a combination of circuitry and executable instructions.

The power supply 104 includes a VCOM power supply 150 and an analog power supply 160. The analog power supply 160 receives the voltage level setting 164 and generates a reference supply voltage 154 according to the voltage level setting. In one embodiment, the voltage level setting 164 may specify a voltage offset that is used by the analog power supply 160 to increase a level of the reference supply voltage 154.

The VCOM power supply 150 also receives the voltage level setting 164 and generates a VCOM supply voltage 152 according to the voltage level setting 164. In one embodiment, the VCOM supply voltage 152 level is approximately half of the reference supply voltage 154 level. For example, the VCOM supply voltage 152 may be 5V and the reference supply voltage may be 10 V. To maintain the VCOM supply voltage 152 at half of the analog power supply voltage 154, the VCOM power supply 150 only increases the VCOM supply voltage 152 by one volt for every two volts that the reference supply voltage 154 is increased. In other embodiments, VCOM may be a voltage that is close to a ground voltage.

In one embodiment, the power supply 104 may be an integrated circuit (IC) or combination of different circuits. The VCOM supply 150 and/or the data driver supply 160 can be implemented with boost converters, linear regulators, charge pumps, or other types of power converters. Additionally, the power supply 104 may also generate additional supply voltages that are not shown in FIG. 1, such as a gate supply voltage for the gate driver 134 and a backlight supply voltage for the backlight 140.

The display panel 106 includes a timing controller 110, a data driver 132, a scan driver 134, a LCD pixel array 130, and a backlight 140. The backlight 140 emits light that is passed through the LCD pixel array 140. The backlight 140 controls the brightness of the light emitted by the backlight 140 according to the backlight brightness setting 166. In one embodiment, the backlight 140 may be a light emitting diode (LED) backlight, a fluorescent backlight, or other type of backlight. The backlight 140 may be located at an edge of the LCD pixel array 130 or may be located directly behind the LCD pixel array 130.

The LCD pixel array 130 includes a matrix or grid of LCD pixels that are coupled to scan lines 190, data lines 192, and the VCOM supply voltage 152. In one embodiment, each LCD pixel includes sub-pixels representing different colors (e.g. red, green blue). The LCD pixels do not produce light, but allow certain amounts of light from the backlight 140 to pass through the LCD pixels in order to produce an image.

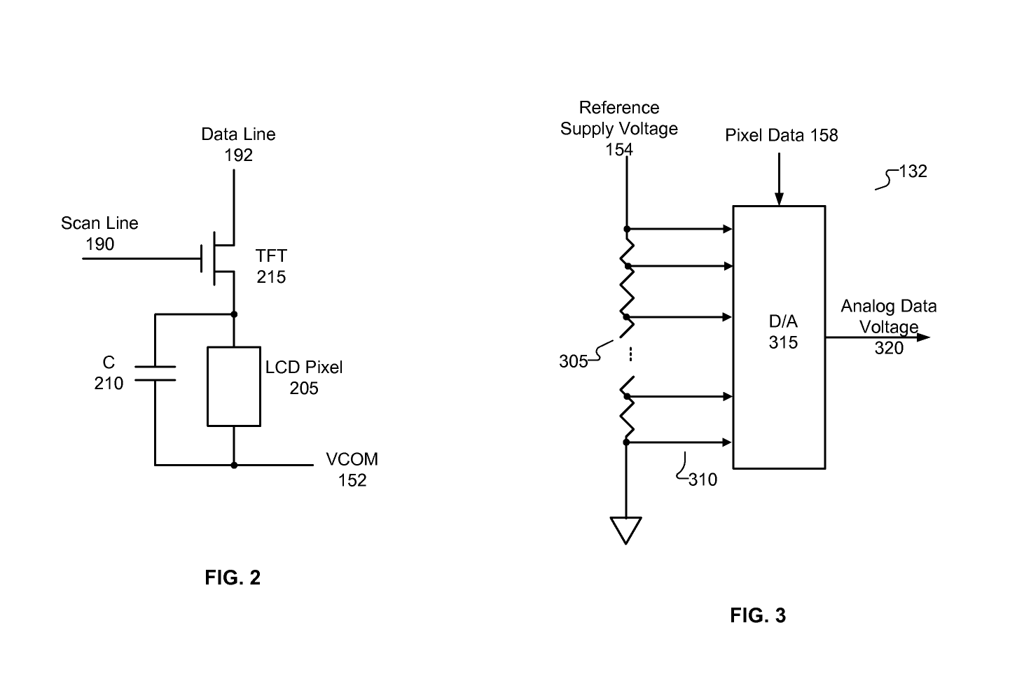

Referring now to FIG. 2, illustrated is an LCD pixel 205 and its supporting circuitry, according to an embodiment. Each LCD pixel 205 is attached to a thin film transistor (TFT) 215 and the VCOM supply voltage 152. The TFT 215 is in turn connected to a data line 192 and a scan line 190. In one embodiment, the transparency of an LCD pixel 205 is set by applying a scan voltage to the gate of the TFT switch 215 via the scan line 190 and then applying an analog data voltage to the source of the TFT 215 via the data line 192. The level of the analog data voltage is stored in the capacitor 210 until the next refresh cycle of the image. The level of the voltage stored in the capacitor 210 is equal to the analog data voltage minus the VCOM supply voltage 152. The voltage across the capacitor 210 controls the amount of light that can pass through the LCD pixel 205.

The VCOM supply voltage 152 may be set to approximately the halfway point between the maximum possible analog data voltage level and the minimum possible analog data voltage level. This allows the voltage potential across the LCD pixel 152 to be switched between negative and positive every so often to prevent burn-in of the LCD pixel 152.

Referring back to FIG. 1, the timing controller 110 receives digital pixel data 156 from the display controller 102 and controls the timing of when the image information represented by the digital pixel data 156 is applied to the LCD pixel array 130. Specifically, the timing controller 110 re-transmits the digital pixel data 158 to the data driver 132. The timing controller 110 transmits driver timing information Td to control when the data driver 132 outputs data voltages onto the data lines 192. The timing controller 110 also transmits gate driver timing information Tg to control when the scan signals are applied to the scan lines 190.

The data driver 132 receives the digital pixel data 158 and performs digital to analog (D-to-A) conversion on the digital pixel data 158 to generate analog data voltages that are applied to the LCD pixel array 130 via the data lines 192. The data driver uses the reference supply voltage 154 as a reference in generating the analog data voltages for the data lines 192. As a result, the dynamic voltage range of the analog data voltages is controlled by a level of the reference supply voltage 154. The scan driver 134 outputs scan signals via the scan lines 190 that cause the analog data voltages generated by the data driver 132 to be applied to the LCD pixel array 130.

Referring now to FIG. 3, illustrated is a more detailed view of a data driver 132, according to an embodiment. The data driver 132 includes a level shifting circuit 305 (e.g. a resistor divider) that generates a series of gamma voltages 310. The gamma voltages 310 decrease sequentially in voltage level so that different levels of gamma voltages 310 are available to the digital to analog (D/A) converter 315 in producing the analog data voltage 320. The highest voltage gamma voltage is equivalent to the reference supply voltage 154 and the lowest gamma voltage is equivalent to GND. In other embodiments, the GND voltage may be replaced by a negative voltage supply or other voltage supply.

The D/A converter 315 receives the digital pixel data 158 and selects one of the gamma voltages 310 that corresponds to the digital value of the digital pixel data 158. In one embodiment, digital values representing lower brightness levels may result in the selection of lower voltage gamma voltages 310, and digital values representing higher brightness levels may result in the selection of higher voltage gamma voltages 310. The selected gamma voltage 310 is then output as the analog data voltage 320.

The dynamic voltage range of the gamma voltages 310 and the dynamic voltage range of the analog data voltages 320 are directly affected by the level of the reference supply voltage 154. A dynamic voltage range can refer to the difference between a maximum and minimum possible voltage. The upper limit of the dynamic voltage range is the reference supply voltage 154 and the lower limit of the dynamic voltage range is GND. As the reference supply voltage 154 increases in voltage level, so does the dynamic voltage range of the gamma voltages 310 and analog data voltages 320. The increased dynamic voltage range of the analog data voltages 320 overdrives the LCD pixel array 130 to increase the light transparency and therefore the brightness of the LCD pixel array 130.

In one embodiment, the gamma voltages 310 can be logically divided into a set of voltages that are higher than VCOM 152 and a set of voltages that are lower than VCOM 152. The data driver 132 may also include a burn-in prevention input (not shown) that controls whether the higher voltage set or lower voltage set is used by the D/A converter 315 in generating the analog data voltages 320. The burn-in prevention input may be periodically switched from one state to another so that voltage drop across the LCD pixel 205 can be switched from positive to negative from time to time. In one embodiment, the burn-in prevention input is produced by the timing controller 110.

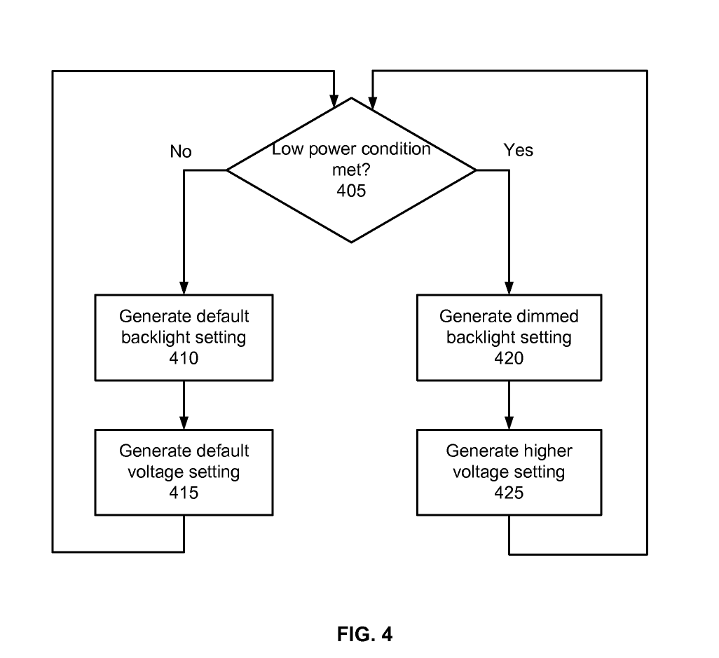

FIG. 4 is a flowchart illustrating a method performed in the display device 100, according to an embodiment. In one embodiment, the method is performed by the power control module 108 in conjunction with other components of the display device 100. In step 405, the power control module 108 determines if a low power condition has been met that would trigger a low power mode. Examples of low power conditions that can cause the display device 100 to enter a low power mode include (1) the expiration of a pre-determined amount of time (2) a high temperature in the display device 100 (3) operating the display device 100 on battery power instead of AC power (4) no change in the image being displayed at the display device 100 for a pre-determined amount of time and (5) a user of the display device 100 providing a user input to place the display device 100 into a low power mode.

If a low power condition is not met, the power control module 108 enters a default power mode. In step 410, the power control module 108 generates a backlight brightness setting 166 for setting the backlight 140 to a default brightness level. In step 415, the power control module 108 generates a voltage setting 166 for setting the reference supply voltage 154 and VCOM supply voltages 152 to a default voltage level.

On the other hand, if a low power condition is met, the power control module 108 enters a low power mode. In step 420, the power control module 108 generates a backlight brightness setting 166 for setting the backlight to a reduced brightness level. The default backlight brightness setting may be adjusted to result in the reduced backlight brightness setting, which results in an adjustment to the backlight control signal. The reduced backlight brightness setting 166 causes the backlight to dim the brightness of the light emitted by the backlight 140 when compared to the default brightness level. In step 425, the power control module 108 generates a voltage level setting 164 for setting the reference supply voltage 154 and VCOM supply voltage 152 to higher voltage levels. The default voltage setting may be adjusted to result in the increased voltage setting, which results in an adjustment to the supply voltage control signal. The change in the voltage levels causes an increase in the dynamic voltage range of the analog data voltages provided to the LCD pixel array 130, which overdrives the LCD pixel array 130 to compensate for the decreased brightness of the backlight 140.

The following table illustrates examples for different settings of the brightness of the backlight 140, the voltage level of the reference supply voltage 154, and the voltage level of the VCOM supply voltage 152 during the default mode and the low power mode.

TABLE 1

| | Default Mode | Low Power Mode |
|---|---|---|
| Brightness of Backlight 140 | 50% | 40% |
| Reference Supply Voltage 154 | 10 V | 12 V |
| VCOM Supply Voltage 152 | 5 V | 6 V |

As shown in the Table 1, during the default mode the backlight brightness is set to 50% brightness. The reference supply voltage 154 is set to 10 volts, and VCOM supply voltage 152 is set to 5 volts. During the low power mode, the backlight brightness is decreased to 40%. The decreased backlight brightness would normally cause a decrease in the brightness of the image produced by the display device 100. To counteract the decreased backlight brightness, the reference supply voltage 154 is increased to 12 volts and the VCOM supply voltage 152 is increased to 6 volts to over-drive the LCD pixel array 130. Additionally, decreasing the backlight brightness saves a significant amount of power while the increase in the supply voltages 152 and 154 only causes a minimum increase in power consumption.

Upon reading this disclosure, those of skill in the art will appreciate still additional alternative designs for backlight dimming compensation in a display device. Thus, while particular embodiments have been illustrated and described, it is to be understood that the embodiments are not limited to the precise construction and components disclosed herein and that various modifications, changes and variations which will be apparent to those skilled in the art may be made in the arrangement, operation and details of the method and apparatus of the embodiments disclosed herein without departing from the spirit and scope of the disclosure as defined in the appended claims.

What is claimed is:

1. A display device with backlight dimming compensation, comprising:
a backlight configured to emit light based on a backlight control signal indicative of a brightness setting for the backlight;
a power supply configured to generate a first supply voltage based on a supply control signal indicative of a voltage setting for the power supply;
a data driver configured to convert pixel data into analog data voltages, a dynamic voltage range of the analog data voltages being controlled by the first supply voltage;
a pixel array having a plurality of pixels, transparency of the pixels to the light emitted by the backlight being based on the analog data voltages; and
a power control module configured to determine if a power condition is met and, responsive to the power condition being met, to adjust the backlight control signal to reduce the brightness of the light emitted by the backlight and to adjust the supply control signal to increase the first supply voltage.

2. The display device of claim 1, wherein the dynamic voltage range of the analog data voltages increases when the first supply voltage is increased.

3. The display device of claim 1, wherein the power supply also generates a second supply voltage based on the supply control signal, the second supply voltage provided to each of the pixels of the pixel array, and the second supply voltage increases as the supply voltage control signal is adjusted.

4. The display device of claim 1, wherein the power control module adjusts the backlight control signal and the supply voltage control signal by referencing a look up table of backlight brightness settings and supply voltage settings.

5. The display device of claim 1, wherein the power control module adjusts the pixel data responsive to the power condition being met.

6. The display device of claim 1, wherein the power condition is met if the display device is operating on battery power instead of AC power.

7. The display device of claim 1, wherein the power condition is met if there is an over-temperature condition in the display device.

8. The display device of claim 1, wherein the power condition is met if a pre-determined amount of time has expired.

9. The display device of claim 1, wherein the pixel array is a liquid crystal pixel array.

10. A method for backlight dimming compensation in a display panel, the method comprising:
emitting light from a backlight based on a backlight control signal indicative of a backlight brightness setting for the backlight;
generating a supply voltage based on a supply control signal indicative of a supply voltage setting for the power supply,
converting pixel data into analog data voltages for controlling transparency of a pixel array to the light emitted by the backlight, a dynamic voltage range of the analog data voltages being controlled by the supply voltage;
determining if a power condition is met; and
responsive to the power condition being met, adjusting the backlight control signal to reduce the brightness of the light emitted by the backlight and adjusting the supply control signal to increase the supply voltage.

11. The method of claim 10, wherein the dynamic voltage range of the analog data voltages increases when the supply voltage is increased.

12. The method of claim 10, further comprising:
generating a second supply voltage based on the supply control signal, the second supply voltage provided to each of the pixels of the pixel array,
wherein the second supply voltage increases as the supply voltage control signal is adjusted.

13. The method of claim 10, wherein the backlight control signal and the supply control signal are adjusted by referencing a look up table of backlight brightness settings and supply voltage settings.

14. The method of claim 10, further comprising:
adjusting the pixel data responsive to the power condition being met.

15. The method of claim 10, wherein the power condition is met if the display device is operating on battery power instead of AC power.

16. The method of claim 10, wherein the power condition is met if there is an over-temperature condition in the display device.

17. The method of claim 10, wherein the power condition is met if a pre-determined amount of time has expired.

18. The method of claim 10, wherein converting the pixel data into the analog data voltages for controlling transparency of a pixel array comprises converting the pixel data into the analog data voltages for controlling transparency of a liquid crystal pixel array.
